(19) United States
(12) Patent Application Publication
(10) Pub. No.: US 2014/0019951 A1
(43) Pub. Date: Jan. 16, 2014

(54) MOBILE APPLICATION TRANSLATION

(71) Applicant: RUMIANA PETROVA, OFTERSHEIM (DE)

(72) Inventor: RUMIANA PETROVA, OFTERSHEIM (DE)

(21) Appl. No.: 13/547,110

(22) Filed: Jul. 12, 2012

(51) Int. Cl. G06F 9/44

(52) U.S. Cl. 717/169

(57) ABSTRACT

Various embodiments of systems and methods mobile application translation are described herein. A localizable file, in the mobile application, which is to be translated, may be identified. The identified localizable file is then retrieved from the mobile application. The localizable file, which is in a mobile platform specific format, may then be converted to a to-be-translated file in a translatable format. The to-be-translated file may then be forwarded to a translation system for translating the to-be-translated file. A translated file that includes the translation of the to-be-translated file may then be retrieved from the translation system. The retrieved translated file may then be updated to the mobile application.

### FIELD

Embodiments generally relate to computer systems, and more particularly to methods and systems for translating a mobile application.

### BACKGROUND

Mobile applications are increasingly becoming popular with the rapid increase in the number of mobile phone users. Usually the text in these mobile applications is in English language. With the global reach of the mobile phones, these mobile applications may be used by users who are not well versed with the English language. In this case, the text in the mobile application needs to be translated to the native language of the mobile phone users. Currently available mobile application translation systems require a lot of human effort for translating the mobile application to different native languages, which is undesirable. Further, currently available mobile application translation systems do not allow translators to review the translated mobile application, after the translation.

### BRIEF DESCRIPTION OF THE DRAWINGS

The claims set forth the embodiments with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a method for translating a mobile application, according to an embodiment.

FIGS. 2A-2B is a detailed flow diagram illustrating a method for translating a mobile application, according to an embodiment.

FIG. 3 is an exemplary block diagram illustrating a system for translating a mobile application, according to an embodiment.

FIG. 4A illustrates an exemplary mobile application, according to an embodiment.

FIG. 4B is a block diagram illustrating a help XHTML page included in the mobile application of FIG. 4A, according to an embodiment.

FIG. 4C is a block diagram illustrating the localizable string file of the mobile application of FIG. 4A, according to an embodiment.

FIG. 5 illustrates a translated help XHML page obtained after translating the help XHTML page of FIG. 4B, according to an embodiment.

FIG. 6 illustrates a translated string file obtained after translating the localizable string file of FIG. 4C, according to an embodiment.

FIG. 7 illustrates a mobile application obtained after updating the translated help XHTML page of FIG. 5 and the translated string file of FIG. 6 to the mobile application of FIG. 4, according to an embodiment.

FIG. 8 is a block diagram illustrating a computing environment in which the techniques described for translating a mobile application can be implemented, according to an embodiment.

### DETAILED DESCRIPTION

Embodiments of techniques for mobile application translation are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

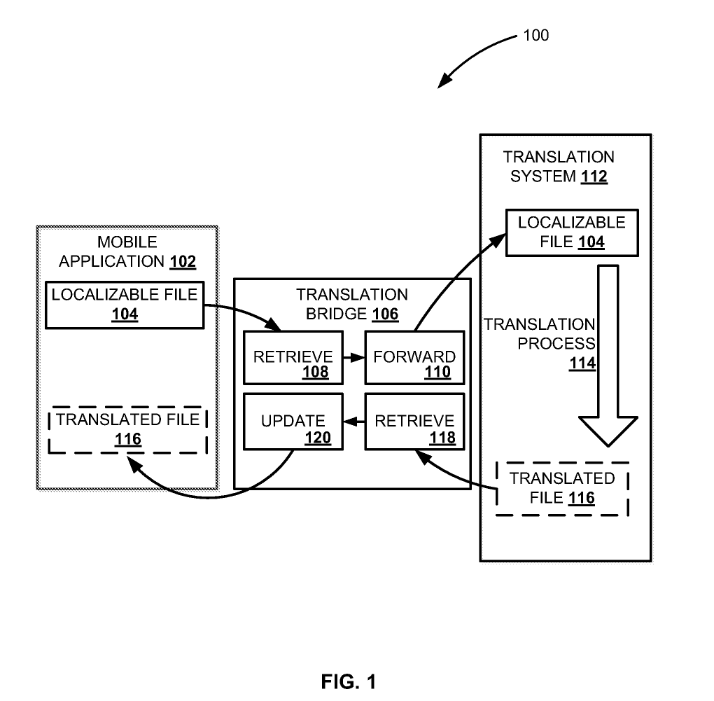

FIG. 1 is a block diagram 100 illustrating a method for translating a mobile application 102, according to an embodiment. A mobile application is a software application designed to run on smartphones, tablet computers, or any other device untethered to wires. The mobile application 102 may be available through application distribution platforms such as the Apple® AppStore^{SM}, Google™ Play, Windows® Phone Marketplace®, Blackberry AppWorld™, etc. The mobile application may be downloaded from the application distribution platform to a target device such as an iPhone®, Blackberry®, Android™ phone, Windows® Phone, etc. The mobile application 102 may include a localizable file 104 that stores the portion of the mobile application 102, such as text, which is to be translated. For example, consider a citizen connect mobile application for iPhone®, which allows a user to report issues, such as potholes, debris, graffiti, or suspicious activities, to their respective municipality. The localizable file of this mobile application may include English language text, for example, the issues such as, traffic light dysfunction, debris, etc., which the user wants the municipality to address.

In one embodiment, a translation bridge 106 automates the translation process of the mobile application 102. The translation bridge 106 may initially identify the localizable file 104, which is to be translated, in the mobile application 102. The translation bridge 106 may then retrieve 108 the localizable file 104 from the mobile application 102. Next the translation bridge 106 forwards 110 the localizable file 104 to the translation system 112 for translation. A translation process 114 may then be performed at the translation system 112 to obtain the translated file 116. The translation bridge 106 then retrieves 118 the translated file 116 from the translation system 112. Finally, the translation bridge 106 updates 120 the translated file 116 to the mobile application 102. After the translation bridge 106 updates 120 the translated file 116, the mobile application 102 includes the localizable file 104 and the translated file 116.

In the above example, the translation bridge retrieves the localizable file of the citizen connect mobile application from the mobile application. The translation bridge may then forward the localizable file to a translation system for translation. At the translation system, the forwarded localizable file may be translated, to another language (e.g., German), to obtain a translated file. In one embodiment, the translated file, obtained after translation, may include German text “Verkehrsampel Körperfunktionsstörung” and “Trümmer” which are translation of the English text, “traffic light dysfunction” and “debris”, respectively, included in the localizable file. The translation bridge may then retrieve the translated file from the translation system. Finally, the translation bridge may update the translated file to the citizen connect mobile application.

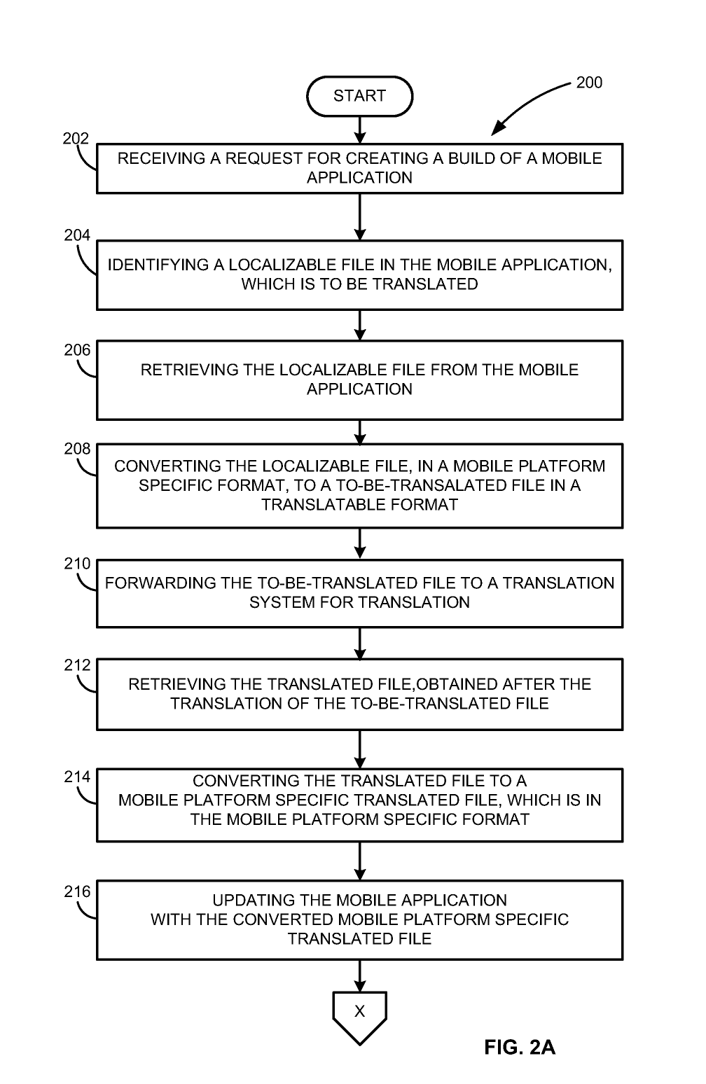

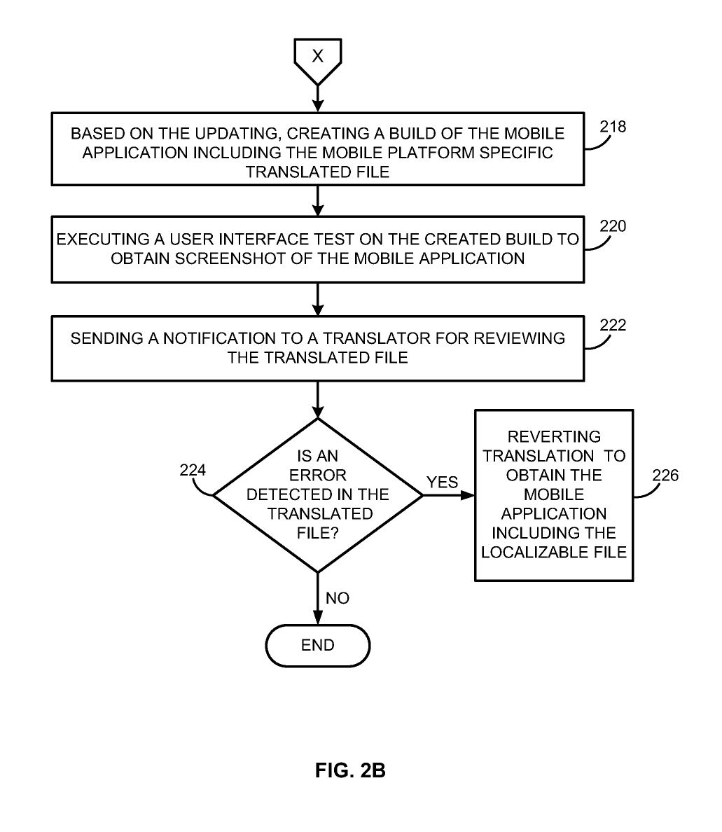

FIGS. 2A-2B is a detailed flow diagram illustrating a method 200 for translating a mobile application, according to an embodiment. The mobile application may include a localizable file storing localizable data, such as text, of the mobile application that is to be translated to different languages. In one embodiment, the localizable file included in the mobile application may be in a mobile platform specific format. For example, if the mobile application is an iOS™ application, an Android™ application, or a Blackberry® application then the localizable file, included in the mobile application, may be in a string format, a XML format, or a RRC format, respectively. The mobile application may also include a metadata file that stores metadata of the mobile application, such as description of the application, keywords associated with the application, etc., included in the corresponding mobile store. For example, if the mobile application is an iOS™ application, an Android™ application, or a Blackberry® application then the mobile application may include metadata file included in the corresponding Apple® AppStore^{SM}, Android Market™, or Blackberry AppWorld™, respectively. The metadata file may be in an XHTML format.

For example, consider two mobile applications a payment approval iOS™ application for iPhone®, and a transport notification and status Android™ mobile application for an Android™ phone. The localizable file, which is a string file, for the payment approval iOS™ application stores English text “payer, bank, amount and status”. The metadata file for the payment approval mobile application stores the description of the mobile application in English language, which includes “With the Payment Approvals mobile application for iPhone®, you can ensure the liquidity of your company by approving payments anywhere and anytime.” The localizable file, which is an XML file, for the transport notification and status mobile application may include English text “Start, End, and Number of Stops”. The metadata file for the transport notification and status application stores the description of the mobile application in English language, which includes “With the transport Notification and Status mobile app for Android™, you can report events that occur when transporting freight orders anywhere, anytime.”

The mobile application may be stored in a source control management (SCM) system, which provides coordination and control during development of the mobile application. The SCM system may include application program interface (API) for uploading the localizable file or the metadata file to the SCM system and downloading translated file and translated metadata file from the SCM system.

Initially at block 202, a build server receives a request for creating a build of the mobile application stored in the SCM system. In one embodiment, the mobile application stores the source code of the mobile application. The build request is received for converting the source code of the mobile application to an executable code. The build request at the build server may be received from a user. The build request may also be automatically triggered based on certain events, for example, the build request may be triggered whenever a file is uploaded or downloaded from the SCM system. In the above example, the build request may be received at a build server for creating build of the payment approval mobile application and the transport notification and status mobile application. Based on the received request, the build server may send a request to a translation bridge for initiating the translation process. In one embodiment, the translation bridge is a software tool, which coordinates the translation of the mobile application.

Next at block 204, the translation bridge initiates the translation of the mobile application by identifying the localizable file in the mobile application. The localizable file may store the portion of the mobile application that is to be translated. In one embodiment, the translation bridge may identify a mobile platform specific file, which is a file in a mobile platform specific format, included in the mobile application as the localizable file of the mobile application. For example, if the mobile application is an iOS™ application then a string file, which is the iOS™ specific file, in the mobile application is identified as the localizable file of the mobile application, if the mobile application is an Android™ application then a XML file, which is the Android™ specific file, in the mobile application is identified as the localizable file in the mobile application, and if the mobile application is a Blackberry® application then a RRC file, which is the Blackberry® specific file, in the mobile application is identified as the localizable file of the mobile application. In one embodiment, the translation bridge may also identify the XHTML file, which is the metadata file, included in the mobile application. For initiating the identification process, the mobile translation bridge may send a connect request to the SCM system. After establishing the connection with the SCM system, the translation bridge may start scanning the mobile applications in the SCM system, one by one, to identify the localizable file included in the mobile application.

In the above example, the translation bridge may start scanning either the payment approval mobile application or the transport notification and status mobile application stored in the SCM system. Assuming, that the translation bridge starts scanning the payment approval iOS™ application, the translation bridge identifies the string file, which is the iOS™ platform specific file, as the localizable file of the payment approval iOS™ application. The mobile translation bridge may also identify the metadata XHTML file included in the payment approval iOS™ application.

Next at block 206 the translation bridge retrieves the localizable file, identified at block 204, from the mobile application. In one embodiment, the translation bridge calls application program interface (API) of the SCM system to retrieve the localizable file and the metadata file from the mobile application. An application programming interface (API) is a specification intended to be used as an interface by software components to communicate with each other. An API may include specifications for routines, data structures, object classes, and variables. The translation bridge may also retrieve the metadata XHTML file from the SCM. In the above example, the mobile translation bridge calls the API of the SCM system to retrieve, the localizable string file that includes the English text “payer, bank, amount, and status” and the metadata XHTML file that includes the English text “With the Payment Approvals mobile application for iPhone®, you can ensure the liquidity of your company by approving payments anywhere and anytime”, from the payment approval mobile application.

Next at block 208 the translation bridge converts the localizable file, which is in mobile platform specific format, to a to-be-translated file, which is in a translatable format. In one embodiment, the conversion is performed for transforming the localizable file in different mobile platform specific formats to a to-be-translated file in a common translatable format. The translatable format may be XML Localization Interchange File Format (XLIFF). XLIFF is an XML-based format created to standardize localization. It specifies elements and attributes to aid in localization. XLIFF forms part of the Open Architecture for XML Authoring and Localization (OAXAL) reference architecture. A to-be-translated file is an XLIFF file obtained after converting the localizable file in a mobile platform specific format. In one embodiment, the translation bridge calls the API of a mobile platform specific converter to convert the localizable file in mobile platform specific format to the to-be-translated file in a translatable format. For example, the translation bridge may call the iOS™ converter, the Android™ converter, or the Blackberry® converter for converting the localizable file of the iOS™ application, the Android™ application, or the Blackberry® application, respectively, to the to-be-translated file in a translatable format. In one embodiment, the localizable file which is in RRC file format, corresponding to the Blackberry® platform, may not be converted to the to-be-translated file in the translatable format. Similarly, the metadata file in XHTML format may also not be converted to a translatable format. In the above example, the translation bridge calls the API of the iOS™ converter for converting the extracted localizable string file of the payment approval mobile application to a to-be-translated file in XLIFF file format.

Next at block 210 the translation bridge forwards the to-be-translated file, obtained at block 208, to a translation system for translation. In one embodiment, the translation bridge calls API of a file system transport tool (FSTT) for forwarding the converted to-be-translated file to the translation system. A FSTT is a software tool that uploads and downloads files, such as the localizable file, from the translation system. The translation bridge may also forward the metadata (XHTML) file to the translation system for translation. At the translation system, translators may translate the to-be-translated file and the metadata file to different languages. The languages to which the to-be-translated file and the metadata file are to be translated may be pre-specified at the translation system by a user. After the translation, a translated file and a translated metadata file may be obtained, which stores the translation of the to-be-translated file and the metadata file, respectively. The obtained translated file may be in same format as the to-be-translated file. For example, if the to-be-translated file is in XLIFF format then the translated file is in XLIFF format. In one embodiment, when the localizable file is not converted to a to-be-translated file, at block 208, then the localizable file may be directly forwarded by the translation bridge to the translation system. In this case, the translated file is in same mobile platform specific format as the localizable file. Similarly the translated metadata file is in same file format (XHTML) as the metadata file.

In the above example, the translation bridge may forward the to-be-translated file and the metadata file of the payment approval mobile application to the translation system. At the translation system a translator may translate the to-be-translated file and the metadata file to German and French or any other language as specified by a user. The translated XLIFF file, obtained after the translation, includes the German translation (“zahler, bank, betrag, und zustand”) and the French translation (“payeur, banque, quantité, and position”) of the English text included in the localizable file. The metadata XHTML translated file includes the German translation (“Mit dem Zahlung Zulassungen mobile app für das iPhone®, können Sie die Liquidität Ihres Unternehmens sicherstellen, durch die Annahme von Zahlungen überall und jederzeit”) and the French translation (“Avec le paiement Approbations application mobile pour iPhone®, vous pouvez assurer la liquidité de votre entreprise par approbation des paiements partout et à tout moment”) of the text included in the metadata file.

Next at block 212 the translation bridge retrieves the translated file, obtained after the translation of the to-be-translated file at block 210, from the translation system. The translation bridge may also retrieve the translated metadata file from the translation system. The translation system may retrieve the translated file and the translated metadata file from the translation bridge after a pre-determined deadline. In one embodiment, the translation bridge calls API of the FSTT to download the translated file from the translation system. In the above example, after a pre-determined deadline, for example 2 days, the translation bridge downloads the translated string file, which include the German and French translation of the to-be-translated file and the translated metadata XHTML file from the translation system.

Next at block 214, the translation bridge converts the translated file, retrieved at block 212, to a mobile platform specific translated file. The translated file in XLIFF format may be converted to a translated file (mobile platform specific translated file), which is in a mobile platform specific file format. For example, a translated XLIFF file, for an iOS™ application may be converted to a translated string file, which is the iOS™ specific file format. The translation bridge may call the API of the mobile platform specific converter for converting the translated file to the mobile platform specific translated file. The translated file corresponding to the localizable file which is not converted at block 208 may not be converted at block 214. In the above example, the translated XLIFF file of the payment approval application may be converted by the iOS™ converter to a string file, which is the iOS™ specific file format.

Next at block 216, the translation bridge updates the mobile application with the mobile platform specific translated file, obtained at block 214. The translation bridge may call the API of the SCM for updating the mobile platform specific translated file to the mobile application stored in the SCM system. The translation bridge may also update the translated metadata file to the mobile application. In case, the translated file is not converted at block 214, then the translation bridge updates the mobile application with the translated file retrieved at block 212. After the update, the mobile application includes the localizable file, the metadata file, the translated file including the translation of the localizable file and the translated metadata file. In the above example, the translated file including the German and French translation of the localizable file and the translated metadata file including the German and French translation of the metadata file are updated to the payment approval mobile application.

Next at block 218, based on updating the mobile application in the SCM system, at block 216, a build of the mobile application including the translated file is created. In one embodiment, after the translation bridge update the translate file in the mobile application, the build process is triggered automatically and the build of the mobile application that includes the translated file and the localizable file is obtained. The build of the mobile application may include an executable code of the mobile application. In the above example, the build of the payment approval mobile application may be created, which includes the localizable file, the metadata file, the translated file including the translation of the localizable file and the translated metadata file. The build of the payment approval mobile application may include the executable code of the mobile application. After the build of the payment approval mobile application is created then the steps in blocks 204-218 may be repeated for the transport notification and status mobile application.

Next at block 220, the translation bridge executes a user interface test on the created build of the mobile application. The execution of the user interface test may generate screenshots of the mobile application that illustrate the translated data included in the translated file of the mobile application. In one embodiment, notification may be sent to the translator for reviewing the translated data, in the translated file, included in generated screenshots (block 222). In another embodiment, the notification may be sent to the translator for reviewing the translated file, included in the mobile application, stored in a shared folder. The translator may review the translated file to identify any discrepancy in the translation. The translator may also review the appearance of the translated file on the mobile device, for example, whether the translated text is too long or inconsistent with the rest of the application. In case an error is detected in the translated file (block 224) then the translation performed on the mobile application may be reverted (block 226). After reverting the translation, the translated file and the translated metadata file updated to the mobile application at block 216 may be removed from the mobile application to obtain the mobile application that includes the metadata file and the localizable file. Next, the steps in blocks 204-226 may be repeated for the mobile application obtained after performing the reverting operation at block 226.

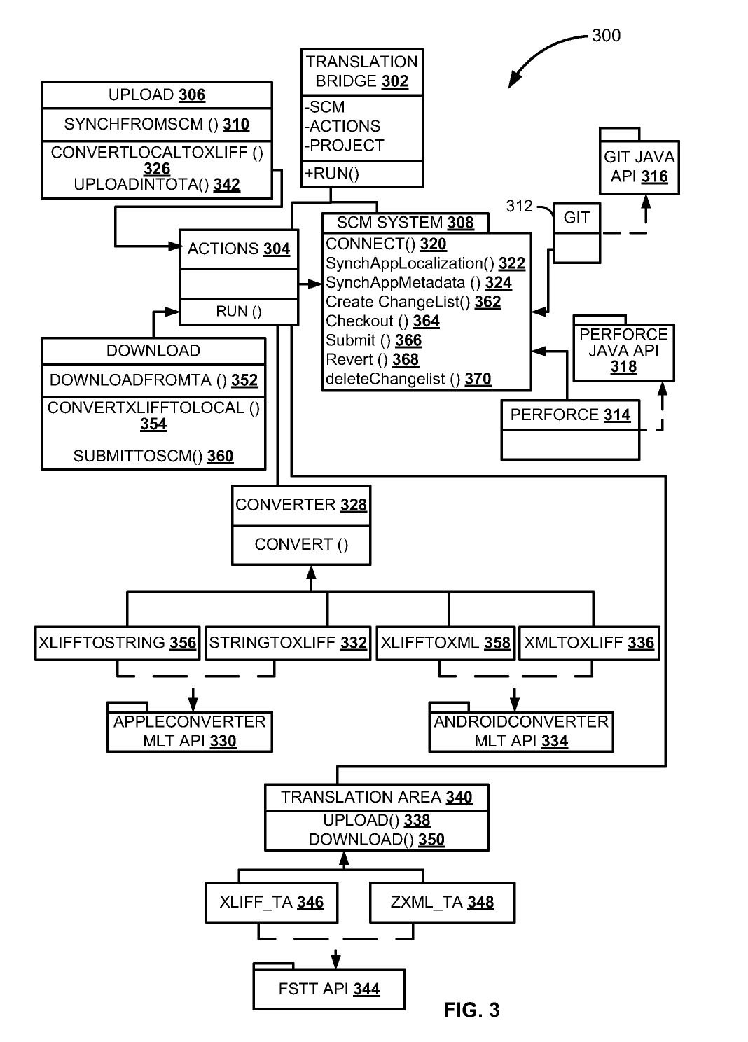

FIG. 3 is an exemplary block diagram illustrating a system 300 for translating a mobile application, according to an embodiment. A translation bridge 302 may perform actions 304 for translating the mobile application. For translating the mobile application, the translation bridge 302 has to upload 306 the localizable file of the mobile application to the translation system. Initially, the translation bridge 302 connects with an SCM system 308 (SYNCHFROMSCM( ) 310) that stores the mobile application. The SCM system 308 may either be GIT 312 or Perforce® 314. The SCM system 308 may also be any other system such as Team Foundation Server (TFS) used for the development of Microsoft® Windows® 8 mobile applications. In case, GIT 312 is being used as the SCM system 308 then the GIT Java API 316 may be called by the translation bridge 302. In case, the Perforce® 314 is being used as the SCM system 308 then the Perforce® Java API 318 may be called by the translation bridge 302. In one embodiment, the translation bridge 302 sends a connect( ) request 320 to the SCM system 308 for connecting with the SCM system 308. After connecting with the SCM system 308, the translation bridge 302 may call the synchAppLocalization( ) 322 API and the synchAppMetadata( ) 324 API for retrieving the localizable file and the metadata file from the mobile application. Next, the translation bridge converts the localizable file to a XLIFF file (CONVERTLOCALTOXLIFF( ) 326). The translation bridge 302 calls the API of a mobile platform specific converter 328 for converting the mobile platform specific localizable file to the localizable XLIFF file. In case the mobile application is an iOS™ application, then the translation bridge 302 calls the Apple® Converter mobile language translation (MLT) API 330 for converting the localizable string file to a to-be-translated XLIFF file (STRINGTOXLIFF 332). In case, the mobile application is an Android™ application then the translation bridge 302 calls an Android™ Converter MLT API 334 for converting the localizable XML file to a to-be-translated XLIFF file (XMLTOXLIFF 336). Next the to-be-translated XLIFF file is uploaded 338 to a translation area (TA) 340 for translating the to-be-translated file (UPLOADINTOTA ( ) 342). The translation bridge 302 calls API of the FSTT 344 for uploading the converted translated file and the metadata file to the translation area 340. The FSTT API 344 may upload the to-be-translated XLIFF file to the translation area 340 (XLIFF_TA 346) or the ZXML, for example XLF or XHTML, file to the translation area 340 (ZXML_TA 346). A translator may then perform the translation on the XLIFF file and the XHTML file to obtain the translated file. The translation bridge 302 may then call the FSTT API 344 for downloading 350 the translated XLIFF file and the translated metadata file from the translation area 340 (DOWNLOADFROMTA( ) 352). Next, the translation bridge 302 may call the API of the mobile platform specific converter 328 to convert the translated XLIFF file to the mobile platform specific translated file (CON VERTXLIFFTOLOCAL( ) 354). In case the mobile application is an iOS™ application then the translation bridge 302 calls the Apple® Converter MLT API 330 for converting the translated XLIFF file to translated string file (XLIFFTOSTRING 356). In case the mobile application is an Android™ application the mobile translation bridge may call the Android™ Converter MLT API 334 for converting the translated XLIFF file to XML file (XLIFFTOXML 358).

Finally the translation bridge 302 submits the mobile platform specific translated file and the translated metadata file to the SCM 308 (SUBMITTOSCM( ) 360). The translation bridge 302 submits the translated file and the translated metadata file to the SCM system 308 for updating the mobile application with the mobile platform specific translated file and the translated metadata file. In one embodiment, for submitting the translated file to the SCM system 308 a changelist is created (CreateChangelist( ) 362) and the mobile platform specific translated file and the translated metadata file are checked out (Checkout ( ) 364)) in the created changelist of the SCM. A changelist identifies the set of changes made in a single commit. The changelist may also represent a sequential view of the source code, allowing the examination of source “as of” any particular changelist ID. Checkout is the process of creating a local working copy from the repository. After the checkout, the translated files in the changelist are submitted (Submit ( ) 366) to the SCM. If the translation bridge 302 detects an error, the created changelist may be reverted (Revert ( ) 368). Finally, after the translated files have been submitted to the SCM the created changelist may be deleted (deleteChangelist ( ) 370).

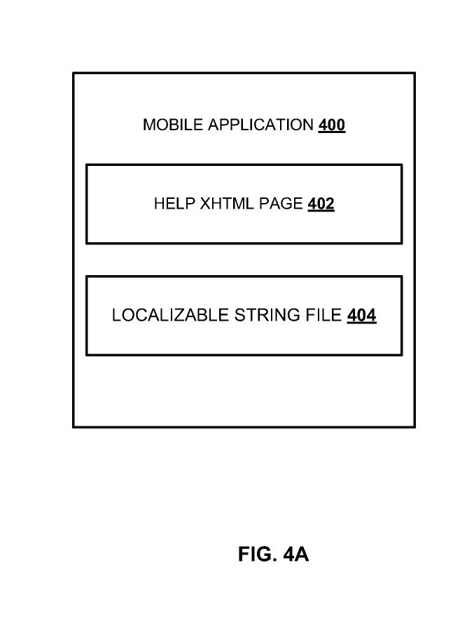

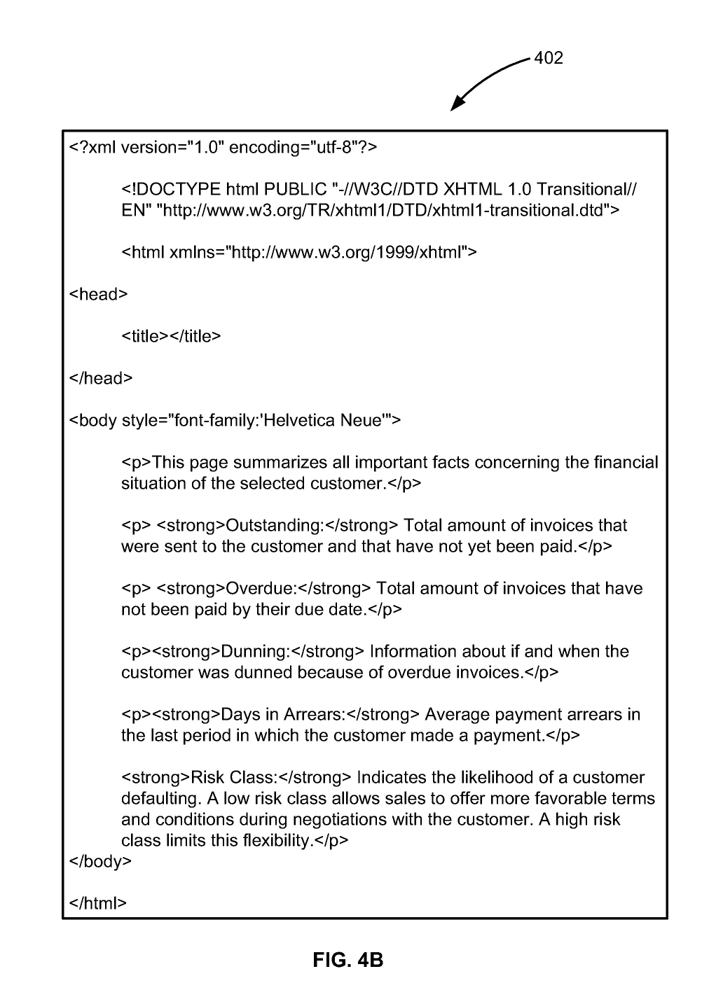

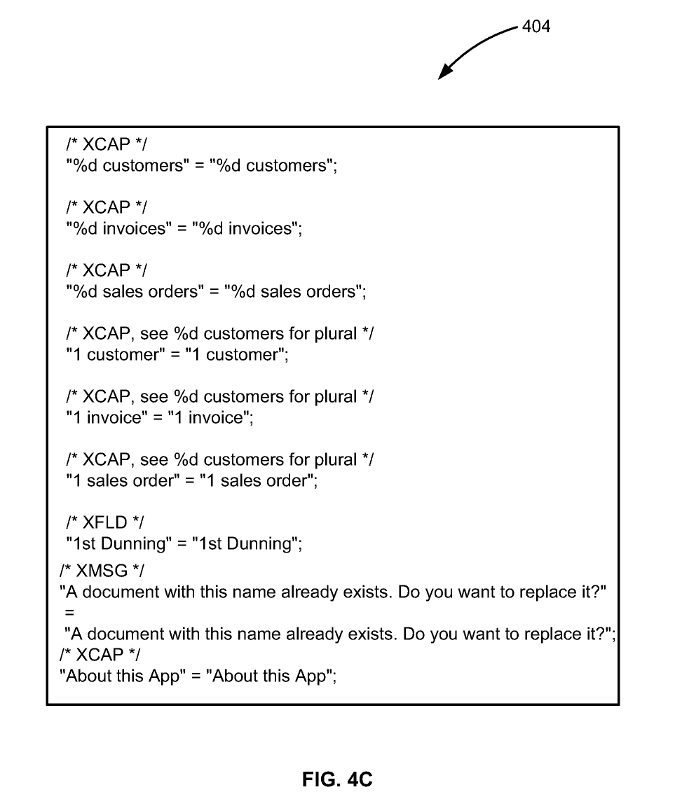

FIG. 4A illustrates an exemplary mobile application 400, according to an embodiment. The mobile application 400 may be an iOS™ mobile application. The iOS™ mobile application 400 includes a help XHTML page 402 and a localizable string file 404. Help pages are part of the mobile application and may be in a same format as the metadata file of the mobile application. The help XHTML page 402 may be stored in the SCM along with the localizable string file 404 and the metadata of the mobile application 400. The iOS™ mobile application 400 may include the source code of the mobile application 400. The iOS™ mobile application 400 is a customer financial fact sheet mobile application.

FIG. 4B is a block diagram illustrating the help XHTML page 402 included in the mobile application 400 of FIG. 4A, according to an embodiment. The help XHTML page 402 includes description of the customer financial fact sheet mobile application. The help XHTML page 402 includes definition of the terms “Outstanding”, “Overdue”, “Dunning”, “Days in Arrears”, and “Risk Class” in English.

FIG. 4C is a block diagram illustrating the localizable string file 404 of the mobile application 400 of FIG. 4A, according to an embodiment. The localizable string file 404 includes the localizable data of the mobile application 400 of FIG. 4A, which is to be translated. A transport bridge retrieves the help XHML page 402 of FIG. 4B and the localizable string file 404 of FIG. 4C from the mobile application 400 of FIG. 4A. The translation bridge may then translate the string localizable file 404 of FIG. 4C to obtain a to-be-translated XLIFF file by calling API of an iOS™ converter. The mobile translation bridge may then forward the to-be-translated XLIFF file and the help XHTML page 402 of FIG. 4B to a translation system, where a translator translates the to-be-translated XLIFF file and the help XHTML page 402 of FIG. 4B to obtain a translated XLIFF file and the translated help XHTML page, respectively, in German language.

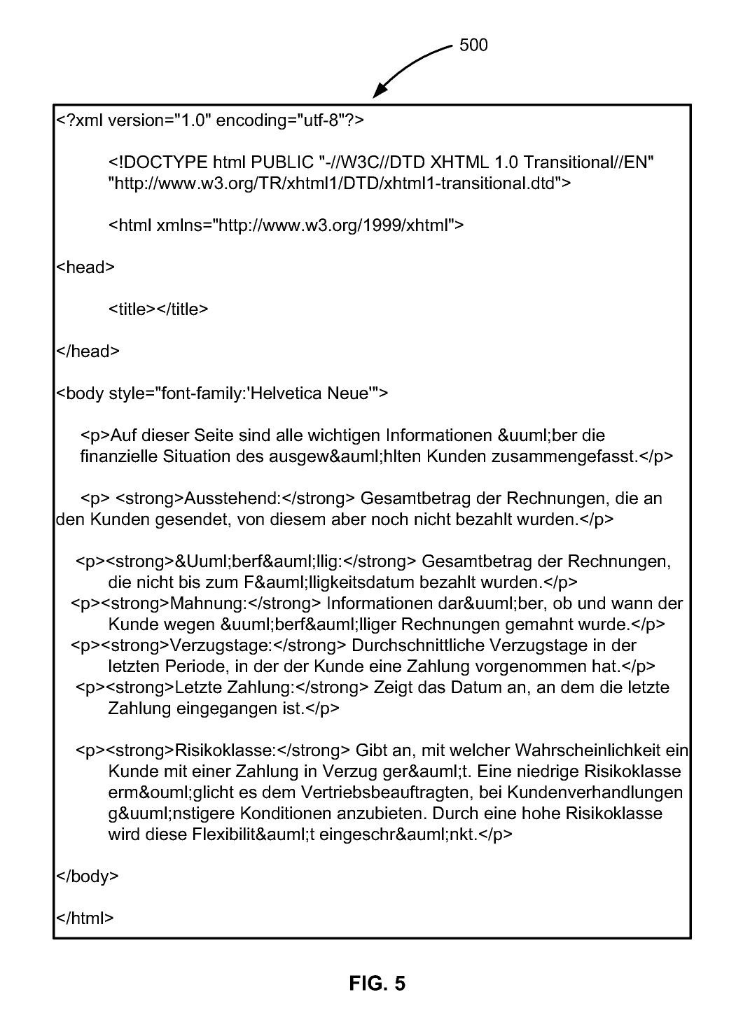

FIG. 5 illustrates a translated help XHML page 500 obtained after translating the help XHTML page 402 of FIG. 4B, according to an embodiment. The translated help XHMTL page 500 is in German language. The translation bridge retrieves the translated help XHTML page 500 from the translation system by calling an FSTT API.

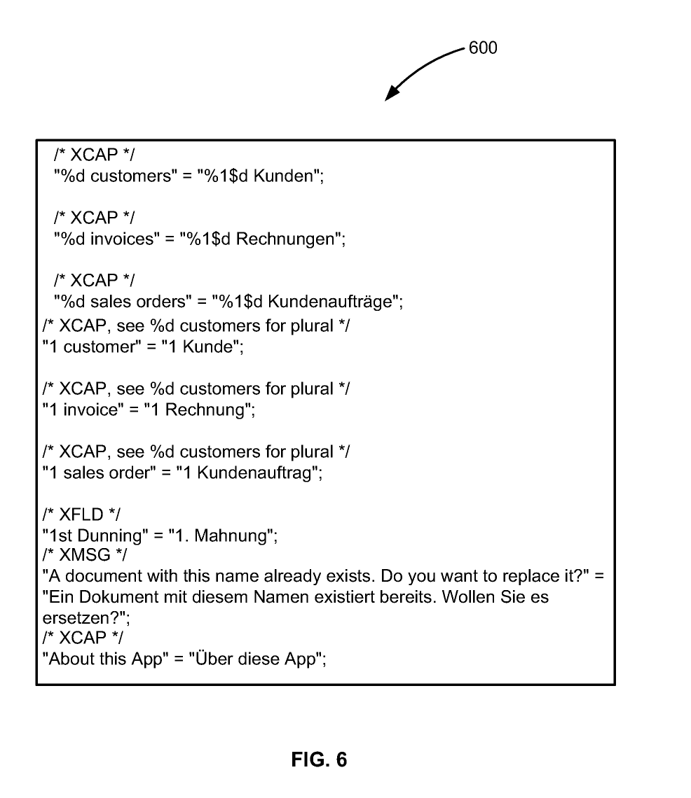

FIG. 6 illustrates a mobile platform specific translated string file 600 obtained after translating the localizable string file 404 of FIG. 4C, according to an embodiment. For obtaining the mobile platform specific translated string file 600, the mobile translation bridge retrieves the translated XLIFF file from the translation system and then converts the translated XLIFF file to the mobile platform specific translated string file 600. The mobile platform specific translated string file 600 is in German language. The translation bridge may call the API of the Apple® platform specific converter for converting the translated XLIFF file to the mobile platform specific translated string file 600.

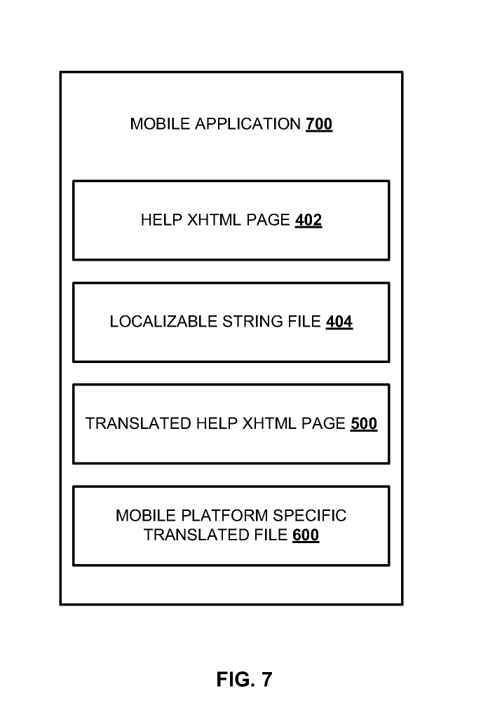

FIG. 7 illustrates a mobile application 700 obtained after updating the translated help XHTML page 500 of FIG. 5 and the mobile platform specific translated string file 600 of FIG. 6 to the mobile application 400 of FIG. 4A, according to an embodiment. As shown, the mobile application 700 may include the help XTHML page 402 of FIG. 4B, localizable string file 404 of FIG. 4B, the translated help XHTML page 500 of FIG. 5, and the mobile platform specific translated string file 600 of FIG. 6. The mobile application 700 of FIG. 7 may be a build of the mobile application 400 of FIG. 4 and may include executable code.

Some embodiments may include the above-described methods being written as one or more software components. These components, and the functionality associated with each, may be used by a client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls or web services being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

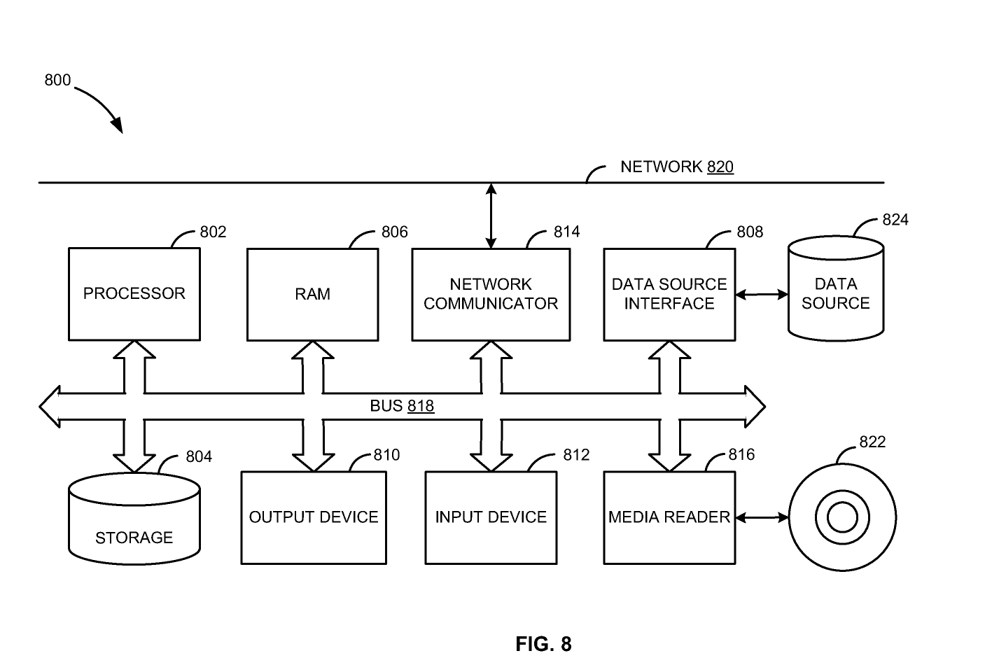

FIG. 8 is a block diagram of an exemplary computer system 800. The computer system 800 includes a processor 802 that executes software instructions or code stored on a computer readable storage medium 822 to perform the above-illustrated methods. The computer system 800 includes a media reader 816 to read the instructions from the computer readable storage medium 822 and store the instructions in storage 804 or in random access memory (RAM) 806. The storage 804 provides a large space for keeping static data where at least some instructions could be stored for later execution. The stored instructions may be further compiled to generate other representations of the instructions and dynamically stored in the RAM 806. The processor 802 reads instructions from the RAM 806 and performs actions as instructed. According to one embodiment, the computer system 800 further includes an output device 810 (e.g., a display) to provide at least some of the results of the execution as output including, but not limited to, visual information to users and an input device 812 to provide a user or another device with means for entering data and/or otherwise interact with the computer system 800. Each of these output devices 810 and input devices 812 could be joined by one or more additional peripherals to further expand the capabilities of the computer system 800. A network communicator 814 may be provided to connect the computer system 800 to a network 820 and in turn to other devices connected to the network 820 including other clients, servers, data stores, and interfaces, for instance. The modules of the computer system 800 are interconnected via a bus 818. Computer system 800 includes a data source interface 808 to access data source 824. The data source 824 can be accessed via one or more abstraction layers implemented in hardware or software. For example, the data source 824 may be accessed by network 820. In some embodiments the data source 824 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

1. A computer implemented method for translating a mobile application, the method comprising:
identifying a localizable file, in the mobile application to be translated;
retrieving, by the processor of the computer, the localizable file from the mobile application;
converting, by the processor of the computer, the localizable file, in a mobile platform specific format, to a to-be-translated file in a translatable format;
forwarding, by the processor of the computer, the to-be-translated file to a translation system for translating;
from the translation system, retrieving, by the processor of the computer, a translated file that includes translation of the to-be-translated file; and
updating, by the processor of the computer, the mobile application with the retrieved translated file.

2. The computer implemented method according to claim 1, wherein updating the mobile application comprises:
converting, by the processor of the computer, the translated file to a mobile platform specific translated file; and
updating, by the processor of the computer, the mobile application with the mobile platform specific translated file.

3. The computer implemented method according to claim 2, further comprising:
based on updating of the mobile application, creating, by the processor of the computer, a build of the mobile application that includes the translated file;
executing, by the processor of the computer, a user interface test on the created build to review the translated file updated to the mobile application; and
based on the review, reverting, by the processor of the computer, update of the translated file to the mobile application.

4. The computer implemented method according to claim 1, wherein identifying the localizable file includes:
identifying, by the processor of the computer, a mobile platform specific file in the mobile application.

5. The computer implemented method according to claim 1, wherein converting the localizable files includes:
calling a mobile platform specific converter API for converting the localizable file to the to-be-translated file in the translatable format.

6. The computer implemented method according to claim 1, wherein forwarding the to-be-translated file to the translation system includes:
calling a file system transport protocol API for forwarding the to-be-translated file to the translation system.

7. The computer implemented method according to claim 1, further comprising:
retrieving, by the processor of the computer, a metadata file from the mobile application;
forwarding, by the processor of the computer, the metadata file to the translation system;
from the translation system, retrieving, by the processor of the computer, a translated metadata file that includes translation of the metadata file; and
updating, by the processor of the computer, the mobile application with the retrieved translated metadata file.

8. A computer system for translating a mobile application comprising:
a memory to store a program code; and
a processor communicatively coupled to the memory, the processor configured to execute the program code to:
identify a localizable file, in the mobile application to be translated;
retrieve the localizable file from the mobile application;
convert the localizable file, in a mobile platform specific format, to a to-be-translated file in a translatable format;
forward the to-be-translated file to a translation system for translating;
from the translation system, retrieve a translated file that includes translation of the to-be-translated file; and
update the mobile application with the retrieved translated file.

9. The computer system of claim 8, wherein the processor further executes the program code to:
convert the translated file to a mobile platform specific translated file; and
update the mobile application with the mobile platform specific translated file.

10. The computer system of claim 9, wherein the processor further executes the program code to:
based on updating of the mobile application, create a build of the mobile application that includes the translated file;
execute a user interface test on the created build to review the translated file updated to the mobile application; and
based on the review, revert update of the translated file to the mobile application.

11. The computer system of claim 8, wherein the processor further executes the program code to:
identify a mobile platform specific file in the mobile application.

12. The computer system of claim 8, wherein the processor further executes the program code to:
call a mobile platform specific converter API to convert the localizable file to the to-be-translated file in the translatable format.

13. The computer system of claim 8, wherein the processor further executes the program code to:
call a file system transport protocol API to forward the to-be-translated file to the translation system.

14. The computer system of claim 8, wherein the processor further executes the program code to:
retrieve the metadata file from the mobile application;
forward the metadata file to the translation system;
from the translation system, retrieve a translated metadata file that includes translation of the metadata file; and
update the mobile application with the retrieved translated metadata file.

15. An article of manufacture including a non-transitory computer readable storage medium to tangibly store instructions, which when executed by a computer, cause the computer to:
identify a localizable file, in the mobile application to be translated;
retrieve the localizable file from the mobile application;
convert the localizable file, in a mobile platform specific format, to a to-be-translated file in a translatable format;
forward the to-be-translated file to a translation system for translating;
from the translation system, retrieve a translated file that includes translation of the to-be-translated file; and
update the mobile application with the retrieved translated file.

16. The article of manufacture according to claim 15, further comprising instructions which when executed by the computer further causes the computer to:
convert the translated file to a mobile platform specific translated file; and
update the mobile application with the mobile platform specific translated file.

17. The article of manufacture according to claim 16, further comprising instructions which when executed by the computer further causes the computer to:
based on updating of the mobile application, create a build of the mobile application that includes the translated file;
execute a user interface test on the created build to review the translated file updated to the mobile application; and
based on the review, revert update of the translated file to the mobile application.

18. The article of manufacture according to claim 15, further comprising instructions which when executed by the computer further causes the computer to:
identify a mobile platform specific file in the mobile application.

19. The article of manufacture according to claim 15, further comprising instructions which when executed by the computer further causes the computer to:
retrieve the metadata file from the mobile application;
forward the metadata file to the translation system;
from the translation system, retrieve a translated metadata file that includes translation of the metadata file; and
update the mobile application with the retrieved translated metadata file.

20. A computer implemented method for translating a mobile application, the method comprising:
identifying a localizable file, in the mobile application to be translated;
retrieving, by the processor of the computer, the localizable file from the mobile application;
converting, by the processor of the computer, the localizable file, in a mobile platform specific format, to a to-be-translated file in a translatable format;
forwarding, by the processor of the computer, the to-be-translated file to a translation system for translating;
from the translation system, retrieving, by the processor of the computer, a translated file that includes translation of the to-be-translated file;
updating, by the processor of the computer, the mobile application with the retrieved translated file;
based on updating of the mobile application, creating, by the processor of the computer, a build of the mobile application that includes the translated file;
executing, by the processor of the computer, a user interface test on the created build to review the translated file updated to the mobile application; and
based on the review, reverting, by the processor of the computer, update of the translated file to the mobile application.
